(19) United States
(12) Patent Application Publication
(10) Pub. No.: US 2024/0031252 A1
(43) Pub. Date: Jan. 25, 2024

(54) METHODS FOR MEASURING USER EXPERIENCE AND SATISFACTION AND IDENTIFYING BOTTLENECKS ON COMMUNICATIONS NETWORKS

(71) Applicant: CelPlan Technologies, Inc., Reston, VA (US)

(72) Inventors: Leonhard KOROWAJCZUK, Herndon, VA (US); Aluísio RIBEIRO, Oakton, VA (US); Arlindo MOREIRA, Great Falls, VA (US); Paulo LEITE, Leesburg, VA (US); Leonardo KOROWAJCZUK, Sterling, VA (US)

(21) Appl. No.: 18/226,088

(22) Filed: Jul. 25, 2023

Related U.S. Application Data
(60) Provisional application No. 63/392,064, filed on Jul. 25, 2022.

(51) Int. Cl. H04L 41/5009; H04W 28/24; G06Q 30/0203

(52) U.S. Cl. CPC H04L 41/5009; H04W 28/24; G06Q 30/0203

(57) ABSTRACT

A method of mapping goodput to user satisfaction on a network includes providing, by at least one processor, users with a data connection having a pre-determined goodput for an average packet transaction of a given category of applications or a snippet of a transaction, receiving, by the at least one processor, user satisfaction ratings from test users after using one or more applications in the given category of applications using the data connection, from the received user satisfaction ratings, generating, by the at least one processor, a graph of average user satisfaction versus goodput for the given category of applications and interpolating between data points to obtain a function correlating user satisfaction and goodput for the given category of applications, and generating, by the at least one processor, a set of functions correlating user satisfaction and goodput for each of a plurality of given categories of applications.

### CROSS-REFERENCE TO RELATED APPLICATIONS

This application claims priority under 35 U.S.C. § 119 to U.S. Patent Application No. 63/392,064 filed Jul. 25, 2022 entitled “METHODS FOR MEASURING USER EXPERIENCE AND SATISFACTION AND IDENTIFYING BOTTLENECKS ON COMMUNICATIONS NETWORKS,” the entire contents of which is incorporated herein by reference.

### TECHNICAL FIELD

This disclosure relates generally to wireless and other network communications, in particular 3G, 4G, and 5G networks and Internet broadband networks. Specifically, this disclosure relates to measuring the user satisfaction on networks, and optimizing them.

### BACKGROUND

Wireless networks have evolved drastically in the last decade. Optimization techniques have not followed this trend, and operators and vendors still resort to drive tests and switch data to optimize them. Both lack an understanding of how networks work today and the result is that networks can appear to function well in these tests, but customers may still be unsatisfied.

Modern wireless networks (3G, 4G, and 5G) have a self-healing characteristic against interference. Due to their adaptive modulation and coding schemes they can adjust their spectral efficiency to the amount of interference present, by trading bandwidth (capacity) for SNR (signal-to-noise ratio) increase. Signal resilience is increased by data repetition (since noise is random), which uses more resources and consequently reduces capacity.

The self-healing property then reduces the network capacity with the increase of interference due to data repetition (which causes more data transmissions to overlap in time). Additionally, by using more resources, inter-cell interference is increased and this creates a cascade effect of interference causing more repetition, resulting in further interference, which propagates throughout the entire network. In summary, congestion in a single cell may cause an impact in the entire network, making it impossible to figure out where the problem started, particularly in a large network where the issue is often a result of several bottlenecks spreading around the network.

Measurements and core KP Is (key performance indicators) may still not show any issues because the network throttles users' traffic and only accepts the amount of traffic it can handle. Users are the only ones that feel the restriction, but may have no way to express it.

Digital communications are provided by ISP (Internet Service Providers), directly or through bandwidth providers (cable, wireless or satellite operators). These providers do adhere to SLA (Service Level Agreements) that are very poorly defined. Regulators, like the FCC (Federal Communications Commission) have established some methods to evaluate the service providers through speed tests. The FCC used test results from the comScore tool in 2010 to evaluate ISPs.

Speed test measurements have been over the years the method used to evaluate Internet connections. The IETF (Internet Engineering Task Force) issued RFC6349, which provides guidelines to measure TCP (Transmission Control Protocol) throughput testing. Many companies implemented variations of this standard, one of the most popular being developed by Ookla as NetGauge in 2006, which is available today as Speedtest.net.

Those speed tests are well accepted by the service providers as they give large numbers, but have no connection to the user experience. It is common to refer to the speed test as the network throughput or instantaneous speed.

Data communications are done today through packet exchange. The most common protocol used for data exchange, which guarantees that the data received comes without errors, is TCP/IP.

Each packet in this protocol has additional information (overhead), that carries origin and destination information as well as content validity information. This protocol requires, in principle, that each packet sent must get an acknowledgement (ACK) back before the next packet can be sent. Flow control can optimize this by providing an ACK for several packets. This implies that there is an interval between packets, which reduces the system capacity. This interval corresponds to the Round-Trip Time (RTT).

Speed tests do not include the overhead and the interval between packets, measuring only the time it takes to transmit the actual data.

The user, however, experiences the entire process, the overhead, the data transmission, and the interval between packets. The industry defines the user experience as goodput (https://en.wikipedia.org/wiki/Goodput), which is defined as the amount of user data transferred over the period from the start of the transmission until the reception of the ACK. The goodput directly impacts the user experience.

Goodput provided by the network varies with the size of the packet. The same network will have a smaller capacity for voice (small packets), then for video (large packets).

Data networks (3G, 4G, and 5G) restrict the user traffic demand to their capacity. Measurement performed on a network, like drive tests or KPI inspections, may find the network flawless, but users may be highly unsatisfied as they are being restricted in their traffic demand by the network (throttling). This happens when the network reaches capacity and the packet exchanges are slowed down. A user message takes longer to reach its destination and consequently the requested information takes longer to reach the user.

### SUMMARY

Embodiments disclosed herein provide systems and methods configured to determine user satisfaction and methods to optimize wireless communications networks considering user satisfaction and the self-healing characteristics of these networks.

One of the challenges is to find out when throttling happens and in what amount. It is possible to characterize the goodput required by the main applications used today in a lab environment, and relate it to different levels of user satisfaction.

Measuring the goodput provided by the network for the applications above and comparing it to the laboratory results allows the calculation of the amount of traffic being throttled.

To optimize a network, it is necessary to calculate the amount of data traffic that would be offered by the users at full satisfaction and to be able to simulate the self-healing mechanism of the wireless network, so the causes of the cascading effect can be removed one by one. This minimizes CAPEX and OPEX.

A new method of mapping goodput to user satisfaction on a network involves: a) providing test users with a data connection having a pre-determined goodput for the average packet size of a given category of applications or an actual capture of such application, b) receiving user satisfaction ratings from the test users after using one or more applications in the given category of applications using the data connection, c) repeating steps a) and b) with a plurality of different pre-determined goodputs, d) from the received user satisfaction ratings, generating a graph of average user satisfaction versus goodput for the given category of applications and interpolating between data points to obtain a function correlating user satisfaction and goodput for the given category of applications, and e) repeating steps a) through d) for a plurality of given categories of applications to generate a set of functions correlating user satisfaction and goodput for the plurality of given categories of applications.

The method may also include determining user satisfaction on a wireless network by measuring goodputs of applications in use by the network users (crowd sourcing or test users) and, for each of the applications (or types), determining the user satisfaction correlated to the measured goodput and category of the in use application. The method may also include determining unconstrained demand/user traffic on the wireless network by determining, from the functions correlating user satisfaction and goodput, the goodput that would result in a highest level of user satisfaction for each user, and determining the demand on the wireless network that would be generated at that level of goodput for each user.

The method may include receiving location information from the network users and, for each network user, mapping the user satisfaction correlated to the measured goodput and category of in use application to a geographic location determined from the location information. Other parameters provided by the user devices can be collected simultaneously.

A new method of identifying bottlenecks in a wireless network may involve defining a traffic pattern on the wireless network for a given time, simulating the traffic pattern in a progressive manner, starting simulated traffic load at a desired first level and increasing the simulated traffic load in small increments and each time a cell reaches its capacity (or a pre-specified threshold), identifying the cell as a bottleneck and intervening to avoid a cascading effect and continuing the increase in simulated traffic until a desired simulated traffic level is achieved.

The steps of the methods may generally be carried out by computer modules, which may, for example, be computer-readable media encoded with special programming. The data connection having a pre-determined goodput may be provided, for example, by providing computer terminals to the users, having a goodput simulation module configured to throttle an available data connection to achieve the pre-determined goodputs. A user satisfaction module may be on the user terminals to receive the user satisfaction ratings from the test users while and/or after using the one or more applications. These modules may be configured to run the simulated goodputs through a predetermined range, activating the user satisfaction module at each goodput to obtain the relevant user satisfaction information. A user satisfaction to goodput correlation module may be on a remote computing device to generate the graphs of average user satisfaction versus goodput and interpolating between data points to obtain the functions correlating user satisfaction and goodput for the given categories of applications.

Measuring goodputs of network users and applications in use by the network users may be carried out by goodput application modules installed on mobile user computing devices and user satisfaction correlated to the measured goodputs may be determined by the goodput application modules or by a remote user satisfaction determination module on a remote application server or other computing device. An unconstrained demand module on the user or remote computing device may be used to determine unconstrained demand on the wireless network.

The location information may be received from the network users via the goodput application modules and mapping of user satisfaction to the geographic locations may be carried out for example by a remote user satisfaction mapping module on the remote application server or other computing device.

Defining a traffic pattern on the wireless network may be carried out by a traffic pattern module on a simulation computing device, or may be defined by input or received data, and the traffic pattern may be simulated in a progressive manner by a progressive traffic pattern simulation module on the simulation computing device. A bottleneck identification module on the simulation computing device may identify cells as bottlenecks and a bottleneck intervention module on the simulation computing device may intervene to avoid cascading effects.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 shows a block diagram of a communications network user experience optimization system according to an example of the instant disclosure.

FIG. 2 is a flowchart of a method of mapping goodput to user satisfaction on a network according to an example of the instant disclosure.

FIG. 3 is a flowchart of a method of identifying bottlenecks in a wireless network according to an example of the instant disclosure.

FIG. 4 shows an example of a system for implementing certain aspects of the present technology.

### DETAILED DESCRIPTION

The invention and the various features and advantageous details thereof are explained more fully with reference to the nonlimiting embodiments that are detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Embodiments of the present invention can be implemented in a computer communicatively coupled to a network (for example, the Internet, an intranet, an internet, a WAN, a LAN, a SAN, etc.), another computer, or in a standalone computer. As is known to those skilled in the art, the computer can include a central processing unit (“CPU”) or processor, at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, etc.), or the like. In embodiments of the invention, the computer has access to at least one database over the network.

ROM, RAM, and HD are computer memories for storing computer-executable instructions executable by the CPU or capable of being complied or interpreted to be executable by the CPU. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of C++, Java, JavaScript, HTML, or any other programming or scripting code. Other software/hardware/network architectures may be used. For example, the functions of the present invention may be implemented on one computer or shared among two or more computers. In one embodiment, the functions of the present invention may be distributed in the network. Communications between computers implementing embodiments of the invention can be accomplished using any electronic, optical, radio frequency signals, or other suitable methods and tools of communication in compliance with known network protocols.

It will be understood for purposes of this disclosure that a module is one or more computer processes, computing devices or both, configured to perform one or more functions. A module may present one or more interfaces which can be utilized to access these functions. Such interfaces include APIs, web services interfaces presented for a web services, remote procedure calls, remote method invocation, etc.

Embodiments disclosed herein provide systems and methods for determining user experience and satisfaction and identifying bottlenecks on communications networks.

To address the issue of wireless network performance, ideally one should determine how much traffic would be offered if the network did not have traffic limitations. When speeds are slow, users are necessarily constrained in their actions. Users do not attempt to watch additional videos or load additional pages when they are still waiting for a first video or page to load. So the amount of data that a user would use if unconstrained cannot be measured directly.

However, from user satisfaction it is possible to infer the amount of traffic that would be offered by the users to the network if the network did not have a traffic restriction.

For this purpose, CelPlan developed a methodology to perform laboratory tests that correlate user satisfaction to network goodput for the most common applications.

Another important question when trying to improve wireless networks is which cells are starting the interference cascade. Answering this question requires an analysis of network performance with progressive traffic growth.

The traffic pattern should be defined, and it must consider the actual carried traffic plus the traffic that was throttled in each cell. Once the traffic pattern is defined for a specific hour of the day, it must be simulated in a progressive manner. For example, the traffic load may start from 0% and be increased in increments of 1%, or some other small increment between e.g. 0.1% and 5%.

Traffic simulation is traditionally done using Monte Carlo simulation, but it does not provide results for all the pixels in the area and can be slow, therefore alternative methods of traffic simulation may be desirable for this purpose, particularly those that consider the traffic in all pixels at the same time to provide the load and consequently provide results in all pixels that carry traffic.

The simulation at low traffic loads does not create throttling or the cascade effect. None of the cells reaches 100% usage of its resources. With the traffic load increase the first cell reaches its capacity, or a critical level, and the network is on the verge of a cascading effect. Intervention is required at this point, to avoid this bottleneck, generally by adding additional cells, or cell pattern shaping. The simulation can then proceed until the next bottleneck and so on until the full traffic capacity is reached, or even beyond, to consider future capacities. In practice, once one bottleneck is relieved, network demand frequently increases until a new bottleneck is created. Thus, the new simulation method allows for efficient network optimization by anticipating future network bottlenecks that are not yet in existence.

By measuring goodput instead of throughput, an improved speed test may be performed that at the same time represents the user experience and can gauge user satisfaction.

Typical applications may be divided into several categories by typical/average packet size (the number of categories is open and can be increased or decreased):
Category 1: Messages: Messager, WhatsApp, and others
Category 2: Voice: Skype, WhatsApp, and others
Category 3: Email: Outlook and others
Category 4: Web browsing: Explorer, Safari, and others
Category 5: Video: YouTube and others
Category 6: File Transfer: FTP and others

For each of these categories, the main commercial applications are evaluated in the laboratory for different goodputs, and User Satisfaction (US) gauged through a MOS (Mean Opinion Score). Thus, User Satisfaction is obtained for each application based on (as a function of) the network goodput. In some embodiments, a goodput may be set manually and user ratings measured, then goodput may be randomly reduced and resulting user ratings can be compared, to map user satisfaction against goodput.

In wireless networks, users move around and User Satisfaction varies from location to location. User Satisfaction and other phone readings may be correlated to geographical locations obtained from GPS and other location algorithms and this information may be sent to a centralized server so that networks may be evaluated geographically. Goodput testing may be performed on test phones, or by applications installed on user phones (crowd sourcing or test phones) with or without their participation and knowledge.

A computer user can use a new goodput speed test to find out the real performance of its ISP and bandwidth provider. The goodput test may be performed by sending a TCP packet and measuring the time between when the packet is sent and the ACK is received, and taking into account the amount of user data contained in the packet. Regulators can evaluate the ISP and bandwidth provider performance against their SLAs. A smartphone user can use the goodput speed test to find the real performance of its wireless provider. Regulators can evaluate the wireless provider performance against their SLAs.

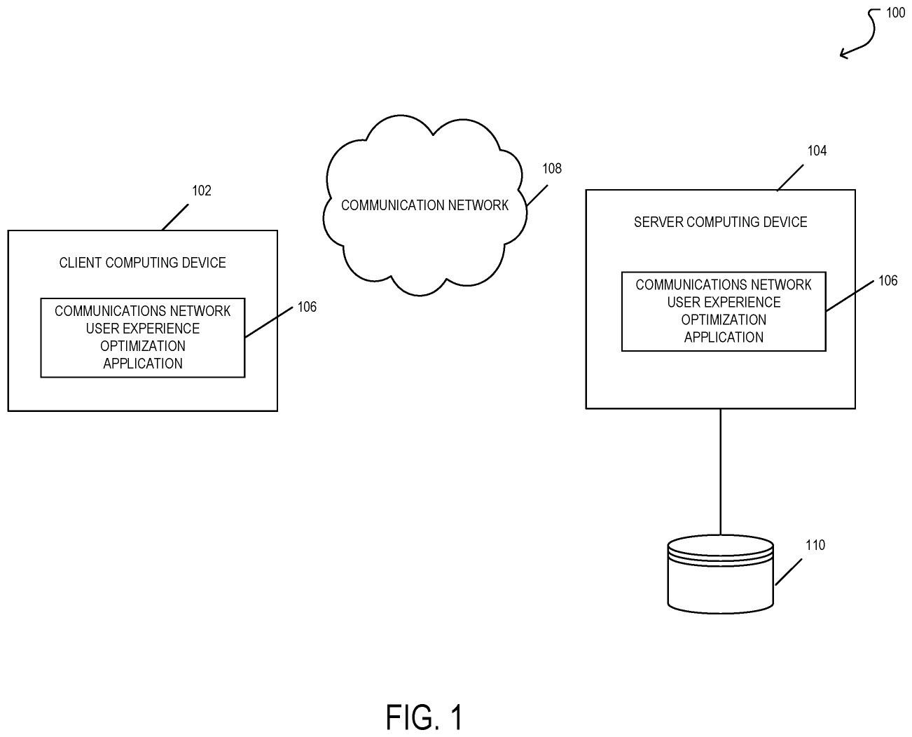

FIG. 1 is a block diagram of a communications network user experience optimization system 100 according to an example of the instant disclosure. The system 100 may include at least one client computing device 102 and at least one server computing device 104. The at least one server computing device 104 may be in communication with at least one database 110.

The client computing device 102 and the server computing device 104 may have a communications network user experience optimization application 106 that may be a component of an application and/or service executable by the at least one client computing device 102 and/or the server computing device 104. For example, the communications network user experience optimization application 106 may be a single unit of deployable executable code or a plurality of units of deployable executable code. According to one aspect, the communications network user experience optimization application 106 may include one component that may be a web application, a native application, and/or an application (e.g., an app) downloaded from a digital distribution application platform that allows users to browse and download applications developed with software development kits (SDKs) including the APPLE® iOS App Store and GOOGLE PLAY®, among others.

The data stored in the at least one database 110 may be associated with the communications network user experience optimization application 106 and the system 100 including goodput information and data, user satisfaction information and data, user satisfaction correlated to goodput for applications in a variety of different categories of applications, and test data from a plurality of client computing devices 102, among other information.

The at least one client computing device 102 and the at least one server computing device 104 may be configured to receive data from and/or transmit data through a communication network 108. Although the client computing device 102 and the server computing device 104 are shown as a single computing device, it is contemplated each computing device may include multiple computing devices.

The communication network 108 can be the Internet, an intranet, or another wired or wireless communication network. For example, the communication network may include a Mobile Communications (GSM) network, a code division multiple access (CDMA) network, 3^{rd} Generation Partnership Project (GPP) network, an Internet Protocol (IP) network, a wireless application protocol (WAP) network, a WiFi network, a Bluetooth network, a near field communication (NFC) network, a satellite communications network, or an IEEE 802.11 standards network, as well as various communications thereof. Other conventional and/or later developed wired and wireless networks may also be used.

The client computing device 102 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the client computing device 102 further includes at least one communications interface to transmit and receive communications, messages, and/or signals.

The client computing device 102 could be a programmable logic controller, a programmable controller, a laptop computer, a smartphone, a personal digital assistant, a tablet computer, a standard personal computer, or another processing device. The client computing device 102 may include a display, such as a computer monitor, for displaying data and/or graphical user interfaces. The client computing device 102 may also include a Global Positioning System (GPS) hardware device for determining a particular location, an input device, such as one or more cameras or imaging devices, a keyboard or a pointing device (e.g., a mouse, trackball, pen, or touch screen) to enter data into or interact with graphical and/or other types of user interfaces. In an exemplary embodiment, the display and the input device may be incorporated together as a touch screen of the smartphone or tablet computer.

The server computing device 104 may include at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions. In addition, the server computing device 104 further includes at least one communications interface to transmit and receive communications, messages, and/or signals.

As an example, the client computing device 102 and the server computing device 104 communicate data in packets, messages, or other communications using a common protocol, e.g., Hypertext Transfer Protocol (HTTP) and/or Hypertext Transfer Protocol Secure (HTTPS). The one or more computing devices may communicate based on representational state transfer (REST) and/or Simple Object Access Protocol (SOAP). As an example, a first computer (e.g., the client computing device 102) may send a request message that is a REST and/or a SOAP request formatted using Javascript Object Notation (JSON) and/or Extensible Markup Language (XML). In response to the request message, a second computer (e.g., the server computing device 104) may transmit a REST and/or SOAP response formatted using JSON and/or XML.

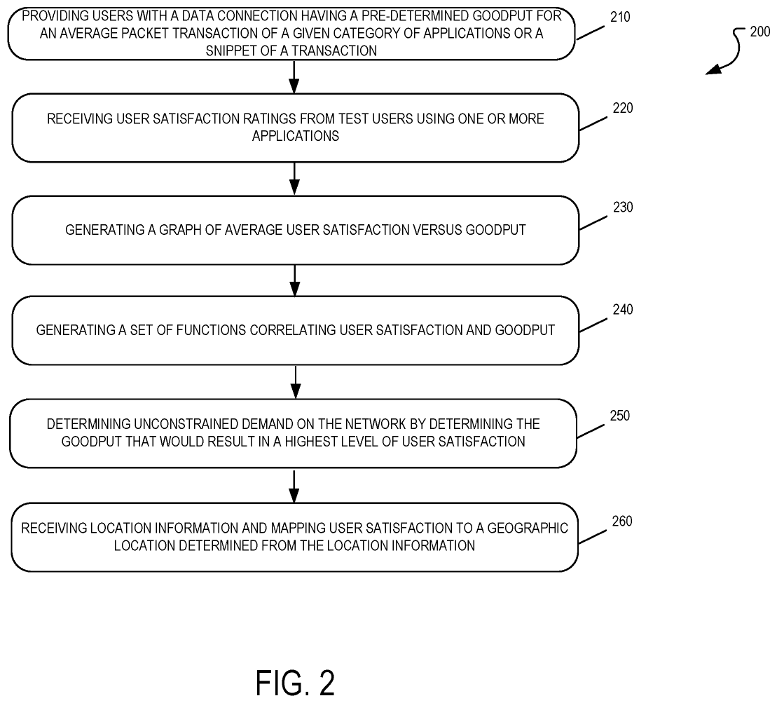

FIG. 2 illustrates an example method 200 of mapping goodput to user satisfaction on a network according to an example of the instant disclosure. Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence.

According to some examples, the method 200 may include providing users with a data connection having a pre-determined goodput for an average packet transaction of a given category of applications or a snippet of a transaction at block 210. In some examples, the pre-determined goodput may be one goodput of a plurality of different pre-determined goodputs. Additionally, in some examples, the plurality of given categories of applications may be messaging applications, voice applications, email applications, web browsing applications, video applications, and file transfer applications, among others. In another example, the plurality of given categories of applications may be applications having the average packet transaction that is within a particular threshold.

As an example, the pre-determined goodput may be an amount of data transferred over a period from a start of a transmission until a reception of an ACK.

According to some examples, the method 200 may include receiving user satisfaction ratings from test users after using one or more applications in the given category of applications using the data connection at block 220.

According to some examples, the method 200 may include, from the received user satisfaction ratings, generating a graph of average user satisfaction versus goodput for the given category of applications and interpolating between data points to obtain a function correlating user satisfaction and goodput for the given category of applications at block 230.

According to some examples, the method 200 may include generating a set of functions correlating user satisfaction and goodput for each of a plurality of given categories of applications at block 240.

According to some examples, the method 200 may include determining unconstrained demand on the wireless network by determining, from the functions correlating user satisfaction and goodput, the goodput that would result in a highest level of user satisfaction for each user, and determining the demand on the wireless network that would be generated at that level of goodput for each user at block 250.

According to some examples, the method 200 may include receiving location information from the network users and, for each network user, mapping the user satisfaction correlated to the measured goodput and category of in use application to a geographic location determined from the location information at block 260.

According to some examples, the network may be a wireless network and the method 200 may include determining user satisfaction on the wireless network by measuring goodputs of network users and applications in use by the network users and, for each of the users, determining the user satisfaction correlated to the measured goodput and category of the in use application.

According to some examples, the method 200 may include evaluating each application in the given category of applications with different goodputs and User Satisfaction (US) gauged through a MOS (Mean Opinion Score).

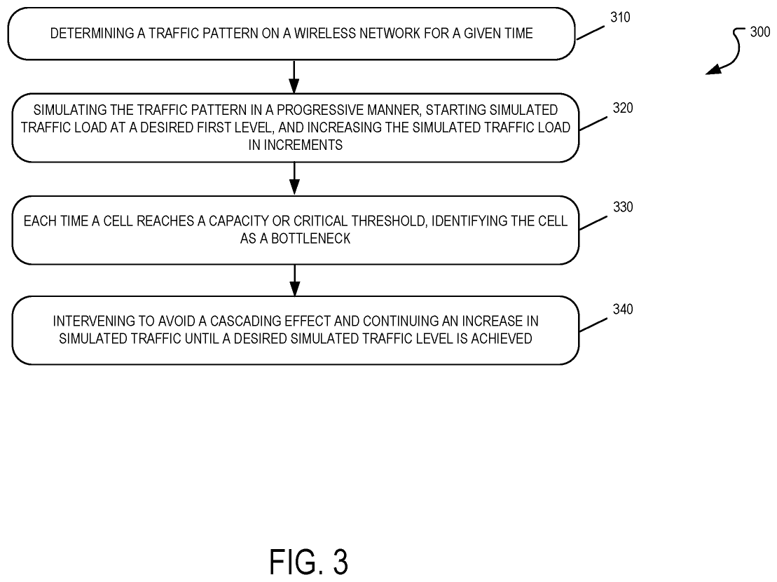

FIG. 3 illustrates an example method 300 of identifying bottlenecks in a wireless network according to an example of the instant disclosure. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some examples, the method 300 may include defining a traffic pattern on the wireless network for a given time at block 310.

According to some examples, the method 300 may include simulating the traffic pattern in a progressive manner, starting simulated traffic load at a desired first level, and increasing the simulated traffic load in increments at block 320.

According to some examples, the method 300 may include each time a cell reaches its capacity or a critical threshold, identifying the cell as a bottleneck at block 330.

According to some examples, the method 300 may include intervening to avoid a cascading effect and continuing the increasing the simulated traffic load until a desired simulated traffic level is achieved at block 340.

According to some examples, in the method 300, the intervening may include at least one of adding at least one additional cell and cell pattern shaping to avoid the cascading effect.

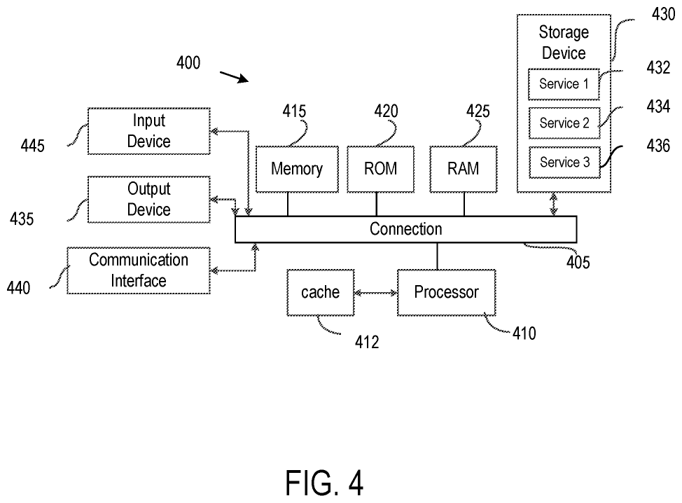

FIG. 4 shows an example of computing system 400, which can be, for example, any computing device making up the computing device such as the client computing device 102, the server computing device 104, or any component thereof in which the components of the system are in communication with each other using connection 405. Connection 405 can be a physical connection via a bus, or a direct connection into processor 410, such as in a chipset architecture. Connection 405 can also be a virtual connection, networked connection, or logical connection.

In some embodiments, computing system 400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 400 includes at least one processing unit (CPU or processor) 410 and connection 405 that couples various system components including system memory 415, such as read-only memory (ROM) 420 and random access memory (RAM) 425 to processor 410. Computing system 400 can include a cache of high-speed memory 412 connected directly with, in close proximity to, or integrated as part of processor 410.

Processor 410 can include any general purpose processor and a hardware service or software service, such as services 432, 434, and 436 stored in storage device 430, configured to control processor 410 as well as a special-purpose processor where software instructions are incorporated into the actual processor design. Processor 410 may essentially be a completely self-contained computing system, containing multiple cores or processors, a bus, memory controller, cache, etc. A multi-core processor may be symmetric or asymmetric.

To enable user interaction, computing system 400 includes an input device 445, which can represent any number of input mechanisms, such as a microphone for speech, a touch-sensitive screen for gesture or graphical input, keyboard, mouse, motion input, speech, etc. Computing system 400 can also include output device 435, which can be one or more of a number of output mechanisms known to those of skill in the art. In some instances, multimodal systems can enable a user to provide multiple types of input/output to communicate with computing system 400. Computing system 400 can include communications interface 440, which can generally govern and manage the user input and system output. There is no restriction on operating on any particular hardware arrangement, and therefore the basic features here may easily be substituted for improved hardware or firmware arrangements as they are developed.

Storage device 430 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 430 can include software services, servers, services, etc., that when the code that defines such software is executed by the processor 410, it causes the system to perform a function. In some embodiments, a hardware service that performs a particular function can include the software component stored in a computer-readable medium in connection with the necessary hardware components, such as processor 410, connection 405, output device 435, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method of mapping goodput to user satisfaction on a network, comprising:
providing, by at least one processor, users with a data connection having a pre-determined goodput for an average packet transaction of a given category of applications or a snippet of a transaction;
receiving, by the at least one processor, user satisfaction ratings from test users after using one or more applications in the given category of applications using the data connection;
from the received user satisfaction ratings, generating, by the at least one processor, a graph of average user satisfaction versus goodput for the given category of applications and interpolating between data points to obtain a function correlating user satisfaction and goodput for the given category of applications; and
generating, by the at least one processor, a set of functions correlating user satisfaction and goodput for each of a plurality of given categories of applications.

2. The method of claim 1, wherein the pre-determined goodput comprises one goodput of a plurality of different pre-determined goodputs.

3. The method of claim 1, wherein the network is a wireless network, the method further comprising determining user satisfaction on the wireless network by measuring goodputs of network users and applications in use by the network users and, for each of the users, determining the user satisfaction correlated to the measured goodput and category of the in use application.

4. The method of claim 3, further comprising determining unconstrained demand on the wireless network by determining, from the functions correlating user satisfaction and goodput, the goodput that would result in a highest level of user satisfaction for each user, and determining the demand on the wireless network that would be generated at the level of goodput for each user.

5. The method of claim 3, further comprising receiving location information from the network users and, for each network user, mapping the user satisfaction correlated to the measured goodput and category of in use application to a geographic location determined from the location information.

6. The method of claim 1, wherein the plurality of given categories of applications comprise messaging applications, voice applications, email applications, web browsing applications, video applications, and file transfer applications.

7. The method of claim 1, wherein the plurality of given categories of applications comprise applications having the average packet transaction that is within a particular threshold.

8. The method of claim 1, wherein the goodput comprises an amount of data transferred over a period from a start of a transmission until a reception of an ACK.

9. The method of claim 1, further comprising evaluating each application in the given category of applications with different goodputs and User Satisfaction (US) gauged through a MOS (Mean Opinion Score).

10. A system for mapping goodput to user satisfaction on a network, comprising:
a memory storing computer-readable instructions; and
at least one processor to execute the instructions to:
provide users with a data connection having a pre-determined goodput for an average packet transaction of a given category of applications or a snippet of a transaction;
receive user satisfaction ratings from test users after using one or more applications in the given category of applications using the data connection;
from the received user satisfaction ratings, generate a graph of average user satisfaction versus goodput for the given category of applications and interpolate between data points to obtain a function correlating user satisfaction and goodput for the given category of applications; and
generate a set of functions correlating user satisfaction and goodput for each of a plurality of given categories of applications.

11. The system of claim 10, wherein the pre-determined goodput comprises one goodput of a plurality of different pre-determined goodputs.

12. The system of claim 10, wherein the network is a wireless network, the at least one processor further to determine user satisfaction on the wireless network by measuring goodputs of network users and applications in use by the network users and, for each of the users, determine the user satisfaction correlated to the measured goodput and category of the in use application.

13. The system of claim 12, the at least one processor further to determine unconstrained demand on the wireless network by determining, from the functions correlating user satisfaction and goodput, the goodput that would result in a highest level of user satisfaction for each user, and determine the demand on the wireless network that would be generated at the level of goodput for each user.

14. The system of claim 12, the at least one processor further to receive location information from the network users and, for each network user, map the user satisfaction correlated to the measured goodput and category of in use application to a geographic location determined from the location information.

15. The system of claim 10, wherein the plurality of given categories of applications comprise messaging applications, voice applications, email applications, web browsing applications, video applications, and file transfer applications.

16. The system of claim 10, wherein the plurality of given categories of applications comprise applications having the average packet transaction that is within a particular threshold.

17. The system of claim 10, wherein the goodput comprises an amount of data transferred over a period from a start of a transmission until a reception of an ACK.

18. The system of claim 10, the at least one processor further to evaluate each application in the given category of applications with different goodputs and User Satisfaction (US) gauged through a MOS (Mean Opinion Score).

19. A method of identifying bottlenecks in a wireless network, comprising:
defining, by at least one processor, a traffic pattern on the wireless network for a given time;
simulating, by the at least one processor, the traffic pattern in a progressive manner, starting simulated traffic load at a desired first level, and increasing the simulated traffic load in increments; and
each time a cell reaches its capacity or a critical threshold, identifying, by the at least one processor, the cell as a bottleneck and intervening to avoid a cascading effect and continuing the increasing the simulated traffic load until a desired simulated traffic level is achieved.

20. The method of claim 19, wherein the intervening further comprises at least one of adding at least one additional cell and cell pattern shaping to avoid the cascading effect.
